(19) United States
(12) Patent Application Publication
(10) Pub. No.: US 2019/0308792 A1
(43) Pub. Date: Oct. 10, 2019

(54) LOW COST ENVIRONMENTALLY SUSTAINABLE SYSTEM FOR LIGHTWEIGHT TRANSPORTING OF MULTIPIECE DOOR COMPONENTS WHICH FORM AN ASSEMBLED DOOR

(71) Applicant: BarnDoorz, Houston, TX (US)

(72) Inventors: John B. Plummer, Houston, TX (US); Erin Hunter Schwarz, Houston, TX (US)

(21) Appl. No.: 16/418,606

(22) Filed: May 21, 2019

Related U.S. Application Data
(60) Provisional application No. 62/653,696, filed on Apr. 6, 2018.

(51) Int. Cl. B65D 81/127

(52) U.S. Cl. CPC B65D 81/127; E06B 3/4636

(57) ABSTRACT

An environmentally sustainable system for transporting alignable multipiece door components including a walled shipping container, a removable insert in the shipping container providing spacing from the walls, at least two multipiece door components, and a component connector in the walled shipping container enveloped by the removable insert. The walls through load transfer via the removable insert support a portion of the multipiece door components within the shipping container during transportation. The shipping container flexes and absorbs only part of and not the entirety of the horizontal forces generated within the door components during door component transportation. When a portion of the door components contacts the portion of the removable insert connected to at least one wall of the shipping container, the door component is prevented from applying a load to the at least one wall of the shipping container which exceeds the elastic limit of the wall of the container.

### CROSS-REFERENCE TO RELATED APPLICATIONS

This application claims the benefit of U.S. Provisional Application No. 62/653,696, filed Apr. 6, 2018, the contents of which are incorporated herein by reference in its entirety to the extend consistent with the present application.

### FIELD

The present embodiment generally relates to an environmentally sustainable system for lightweight transporting of multipiece door components that form an assembled door when assembled.

### BACKGROUND

A need exists for a lightweight sturdy shipping container for door components.

The present embodiments meet these needs.

### BRIEF DESCRIPTION OF THE DRAWINGS

The detailed description will be better understood in conjunction with the accompanying drawings as follows:

FIG. 1 depicts a low cost environmentally sustainable system for lightweight transporting of multipiece door components according to one or more embodiments.

FIG. 2 depicts a perspective view of a removable insert according to one or more embodiments.

FIG. 3 depicts another embodiment of the low cost environmentally sustainable system for lightweight transporting of multipiece door components according to one or more embodiments.

FIG. 4 depicts a front view of a component connector.

FIG. 5 shows a roller assembly usable according to one or more embodiments.

FIG. 6 shows two alignable multipiece door components connected together wherein each alignable multipiece door component has a different size and shape according to one or more embodiments.

FIG. 7 depicts a component connector engaging two alignable multipiece door components as an H shaped connector according to one or more embodiments.

FIG. 8 shows a detail of one of the alignable multipiece door components.

FIG. 9 shows an exploded view wherein a first alignable multipiece door component with connector component is nested inside a removable insert with a spacer.

FIG. 10A shows an assembled door according to an embodiment of the invention.

FIG. 10B shows a rolling barn door according to an embodiment of the invention.

The present embodiments are detailed below with reference to the listed Figures.

### DETAILED DESCRIPTION OF THE EMBODIMENTS

Before explaining the present apparatus in detail, it is to be understood that the apparatus is not limited to the particular embodiments and that it can be practiced or carried out in various ways.

The invention relates to an environmentally sustainable system transporting of alignable multipiece door components that includes a walled shipping container, a removable insert in the shipping container providing spacing from the walls, at least two multipiece door components, and a component connector in the walled shipping container enveloped by the removable insert.

The walls through load transfer via the removable insert support a portion of the multipiece door components within the shipping container during transportation.

The shipping container flexes and absorbs only part of and not the entirety of the horizontal forces generated within the door components during door component transportation.

When a portion of the door components contact a portion of the removable insert connected to at least one wall of the shipping container, the door component is prevented from applying a load to at least one wall of the shipping container which exceeds the elastic limit of the wall of the container.

The embodiments create a low-cost system for shipping of multipiece door components by reducing packaging and shipping costs.

The system transports multipiece door component in a manner that does not have to be shipped by freight.

The system allows multipiece door components to be shipped and disposed in an environmentally sustainable manner.

The system provides a packaging that is lightweight by reducing the load of the shipping container.

The term “removable insert” as used herein can be refer to BUBBLE WRAP®, a structural open cell foam, a structural polystyrene foam, a structural polyurethane foam, and a sprayed in place rubber-based insert

The term “roller assembly” as used herein can refer to rollers, rails, supports, stoppers, end caps, and spacers for installing multipiece door components.

A low cost environmentally sustainable system for lightweight transporting of alignable multipiece door components that form an assembled door.

The low cost environmentally sustainable system includes a walled shipping container 10 having a top 14 with a plurality of walls 12a-d around a first face 17, engaging a separate disconnected bottom 16 with a plurality of walls 12e-h around a second face. The walled shipping container is a two-component system.

A removable insert in the walled shipping container provides impact damping and spacing from the walls, the top, and the bottom simultaneously with the damping heightened by the removable insert covering at least 80 percent surface area of the walls, the top and the bottom.

The removable insert has a face with integral walls forming a lining inside the top snugly engaging the top.

A plurality of alignable multipiece door components are in the walled shipping container is enveloped by the removable insert on five sides.

A removeable protective spacer covers the plurality of alignable multipiece door components.

A component connector is in the walled shipping container and is enveloped by the removable insert for engaging pairs of the plurality of alignable multipiece door components.

A plurality of fasteners are contained in the walled shipping container for engaging the plurality of alignable multipiece door components through predrilled holes in the component connector forming an assembled door.

The walls, through load transfer via the removable insert, support a portion of the alignable multipiece door components within the walled shipping container during transportation.

The walled shipping container is designed to flex and absorb only part of and not the entirety of the horizontal forces generated by the internally contained alignable multipiece door components during transport so that when a portion of the alignable multipiece door components contacts the portion of the removable insert connected to at least one wall of the walled shipping container, each alignable multipiece door component is simultaneously prevented from applying a load to each wall of the walled shipping container which exceeds the elastic limit of each wall of the walled shipping container.

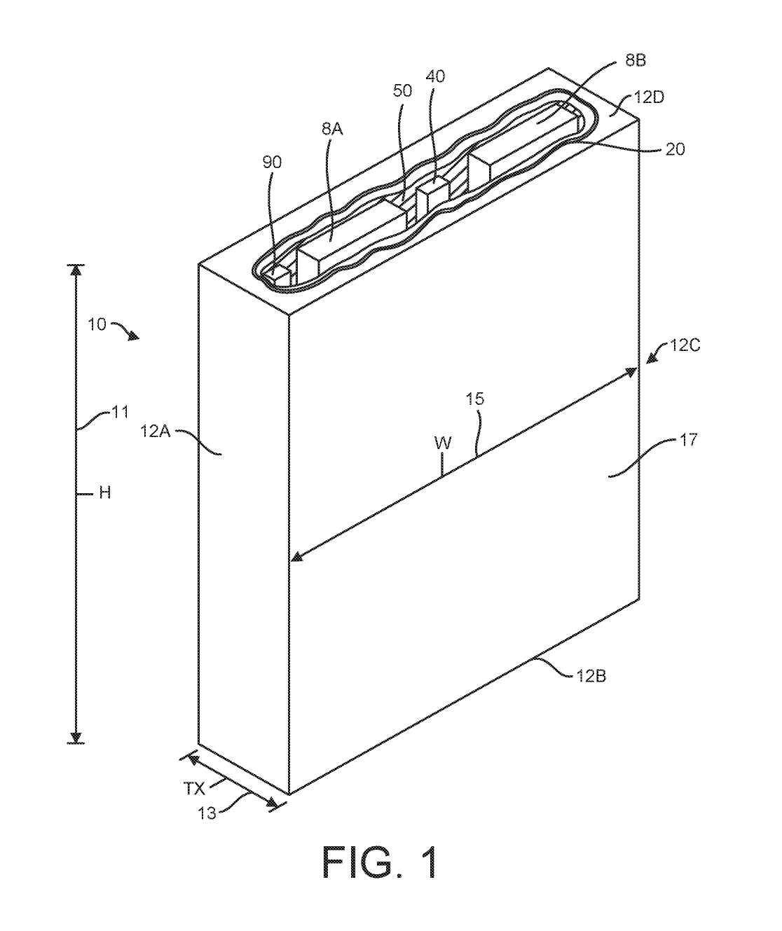

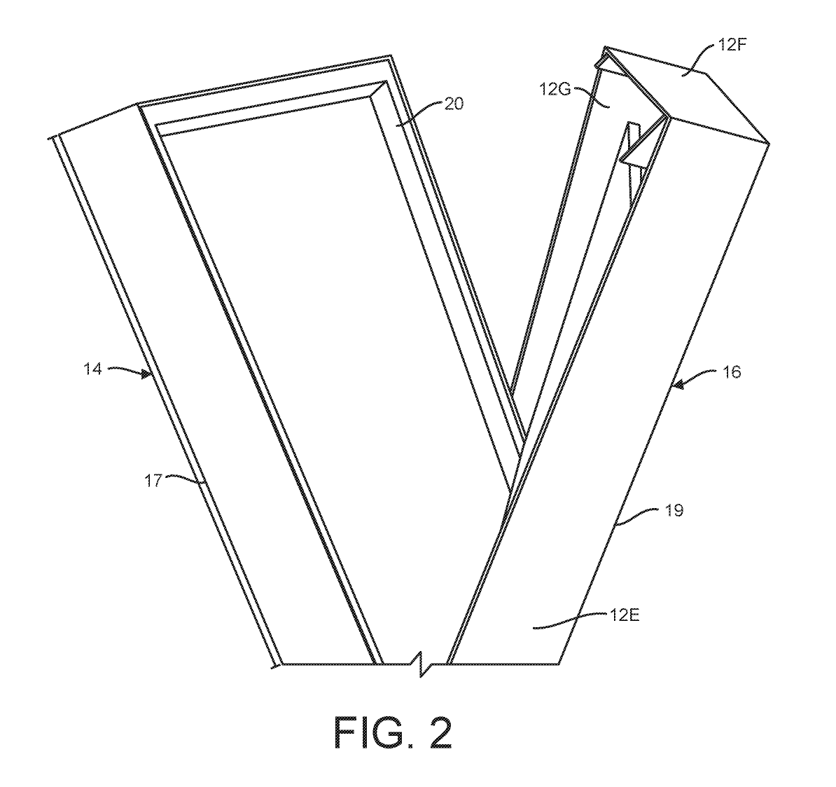

Turning now to the Figures, FIGS. 1-2 depicts a low cost environmentally sustainable system 10 for lightweight transporting of multipiece door components 8a, 8b which form an assembled door when assembled.

The low cost environmentally sustainable system has a walled shipping container 10 has a top 14 (shown in FIG. 2) detachable from a bottom 16 (also shown in FIG. 2 forming the assembly shown in FIG. 1.

The top 14 has a plurality of walls 12a-d around a first face 17 as shown in FIG. 1.

The bottom 16 has a plurality of walls 12e-h around a second face 19 as shown in FIG. 2.

The top 14 with walls 12a-12d, extending over and slides over the walls of the bottom 16, that is, the top fits over the bottom.

FIG. 1 shows the walled shipping container having a height (H) labeled as element 11.

FIG. 1 shows the walled shipping container having a thickness (T) labeled as element 13.

FIG. 1 shows the walled shipping container having a width (W) labeled as element 15.

The walled shipping container has a girth plus length of no more than 165 inches with a width 15 from 10 inches to 50 inches, and a height 11 from 6 inches to 100 inches and a thickness 14 from 4 inches to 20 inches.

The walled shipping container walls are single wall, double walled, triple walled, or reinforced multi-walls.

The walled shipping container independently or in combination contains the multipiece door components 8a and 8b as well as a removable insert 20 that specifically provides impact damping and spacing from each of: (i) the walls, (ii) the top and (iii) the bottom simultaneously by covering at least 80 percent surface area of the walls, the face of the top.

In embodiments, a plurality of multipiece door components 8a and 8b in the shipping container can be enveloped by the removable insert 20.

In embodiments, each alignable multipiece door component is from 5% to 50% less than at least two dimensions of the removable insert.

The removable insert can be a member of the group BUBBLE WRAP®, a structural open cell foam, a structural polystyrene foam, a structural polyurethane foam, and a “sprayed in place” rubber-based insert.

In embodiments, a component connector 40 contained in the walled shipping container can be enveloped by the removable insert 20 for engaging pairs of multipiece door components forming an assembled door.

The walls, through load transfer via the removable insert, support a portion of the multipiece door components within the shipping container during transportation.

The walled shipping container can be designed to flex and absorb only part of and not the entirety of the horizontal forces generated by the multipiece door components during door component transportation so that when a portion of the multipiece door components contact the portion of the removable insert connected to at least one wall of the walled shipping container.

The multipiece door component can be prevented from applying a load to at least one wall of the walled shipping container which exceeds the elastic limit of the wall of the walled shipping container.

A finish protection bag 50 is depicted for containing the multipiece door components.

The finish protection bag 50 for the low cost environmentally sustainable system for lightweight transporting of plurality of alignable multipiece door components, encapsulates the low cost environmentally sustainable system for lightweight transporting of plurality of alignable multipiece door components within the removable insert.

The finish protection bag 50 can be 1-3 mils thick and flexible and pliable and waterproof.

The finish protection bag can contain the component connector 40 in embodiments.

Assembly instructions 90 are also depicted contained in the walled shipping container interior of the removable insert.

The assembly instructions 90 can include a URL address connecting to online instructions or computer readable digital media contained in the walled shipping container playable on a client device of an assembler.

FIG. 2 depicts an embodiment of the top and bottom disconnected from each other with the removable insert 20 and the face 17 of the top and face 19 of the bottom labeled.

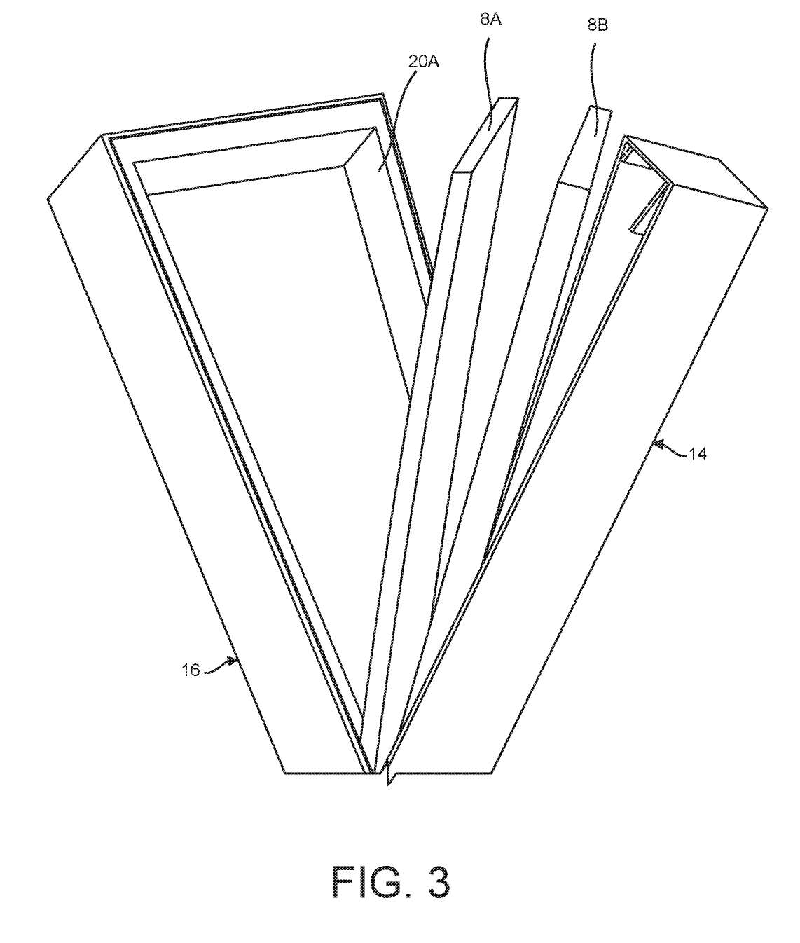

FIG. 3 depicts another embodiment of the low cost environmentally sustainable system for lightweight transporting of multipiece door components according to one or more embodiments.

FIG. 3 shows a first alignable multipiece door component 8A and a second alignable multipiece door component 8B.

The first alignable multipiece door component is nested inside of a first removable insert 20A that is nested within the bottom 16 in this embodiment.

A second removable insert, which is in the shape of a flat board, a rectangle slides over the first alignable multipiece door component.

A second alignable multipiece door components 8B slides over the second removable insert and the top 14 slides over the entire unit including the bottom 16.

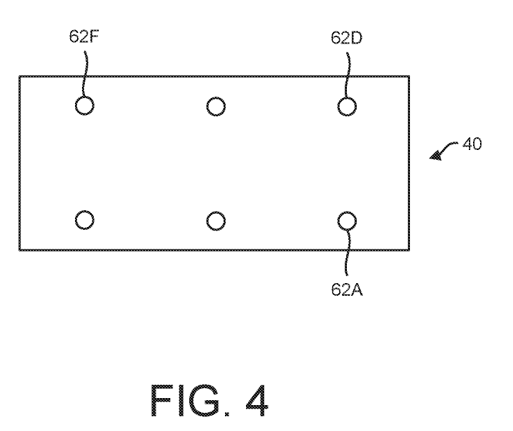

FIG. 4 depicts a front view of a component connector 40 with predrilled holes 62a-62f.

The plurality of predrilled and the plurality of fasteners 64a-64f enable quick and fast engagement of a first multipiece door component to a one or more subsequent multipiece door components.

In embodiments, the component connector has from 4 to 30 predrilled holes and from 4 to 30 fasteners for installation in the predrilled holes connecting a first alignable multipiece door component to a one or more subsequent door components.

The fasteners are included in the walled shipping container.

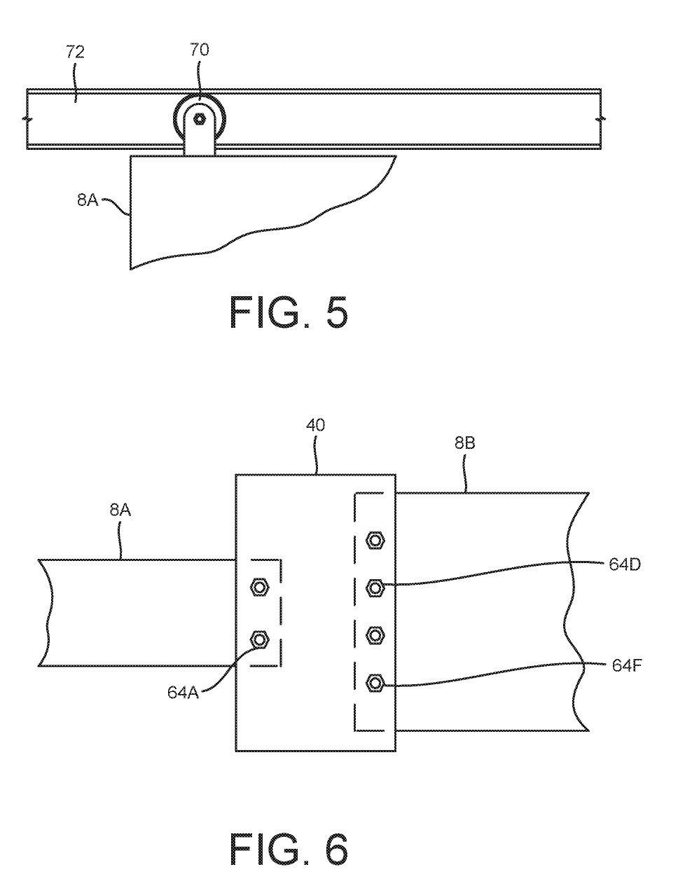

FIG. 5 depicts a side view of one of the alignable multipiece door components according to one or more embodiments.

FIG. 5 shows a roller assembly usable according to one or more embodiments.

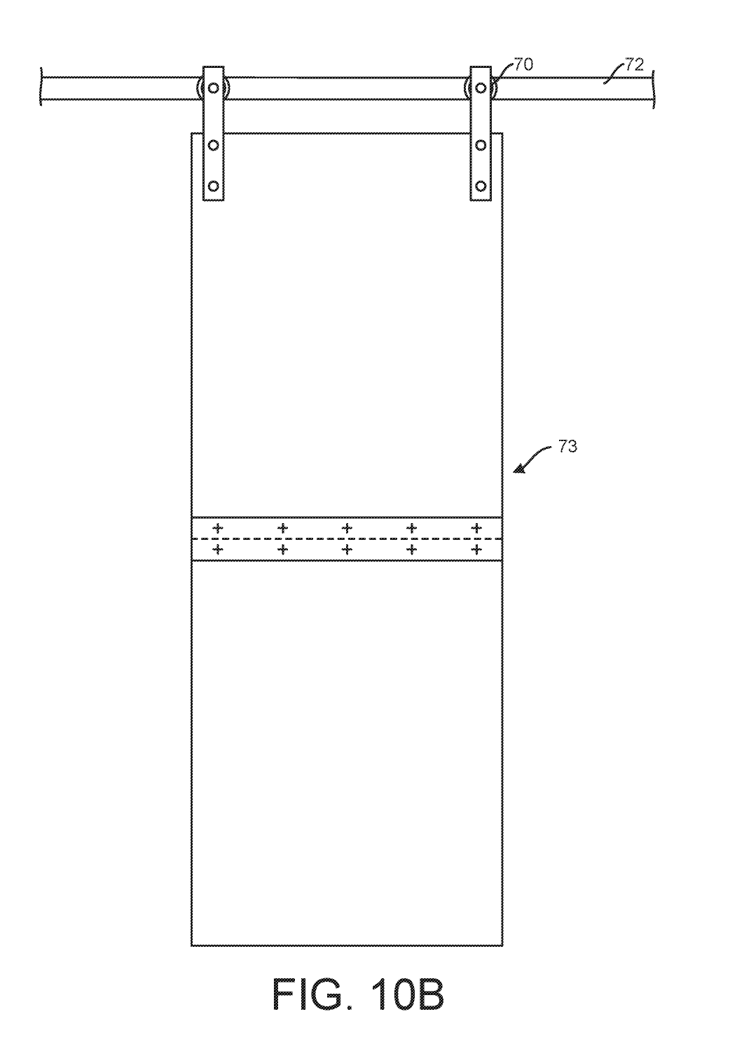

One or more door rollers 70 can be used for supporting an assembled door on an installed rail 72 forming a rolling barn door. One of the multipiece door components 8A is shown. The rolling barn door is depicted assembled in FIGS. 10A and 10B as element 73.

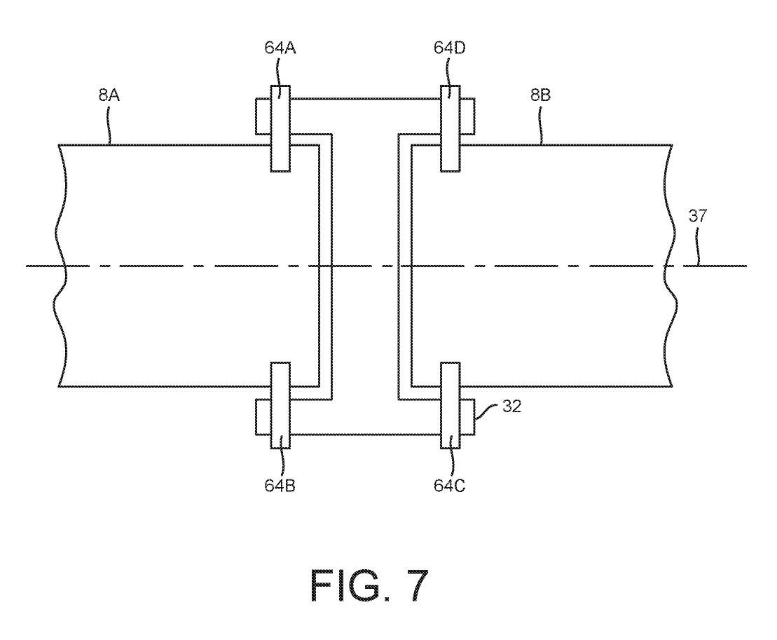

FIG. 6 shows an assembled door using a connector 40 with at least two alignable multipiece door components 8A and 8B to form an assembled door, wherein the door components are not identical in a shape or size.

In embodiments, the door components can be identical in shape.

In embodiments, the door components can be identical in size but not in shape.

In embodiments, the at least two alignable multipiece door components to form an assembled door are not identical in at least one of: a shape and a size.

The fasteners are depicted as elements 64A-64F. The fasteners can be bolts with nuts.

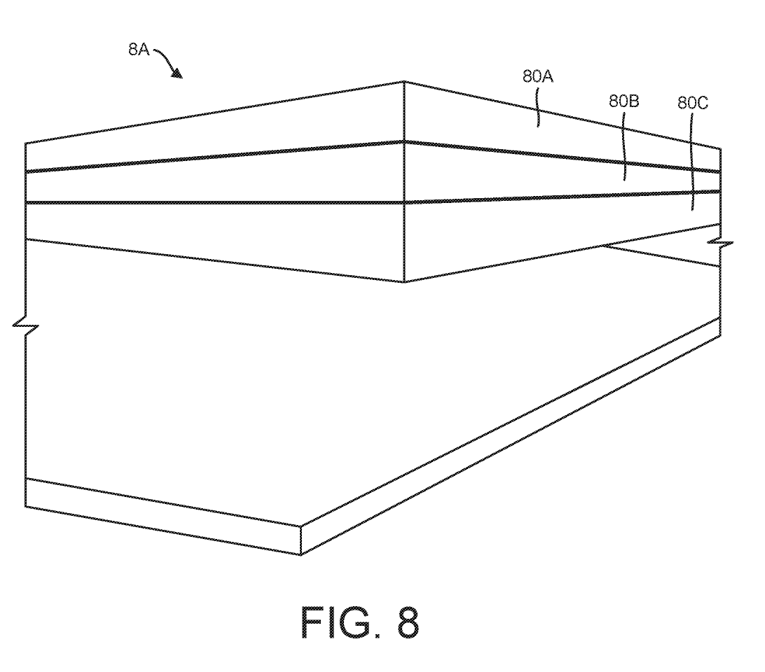

FIG. 7 shows a component connector 40 as an H shaped connector 32 with a plurality of predrilled holes, and a plurality of fasteners 64A-64D for installation in the predrilled holes connecting a first alignable multipiece door component 8A to one or more subsequent alignable multipiece door components 8B.

In this embodiment, the two alignable multipiece door components of the plurality of alignable multipiece door components are aligned on a common vertical axis 37.

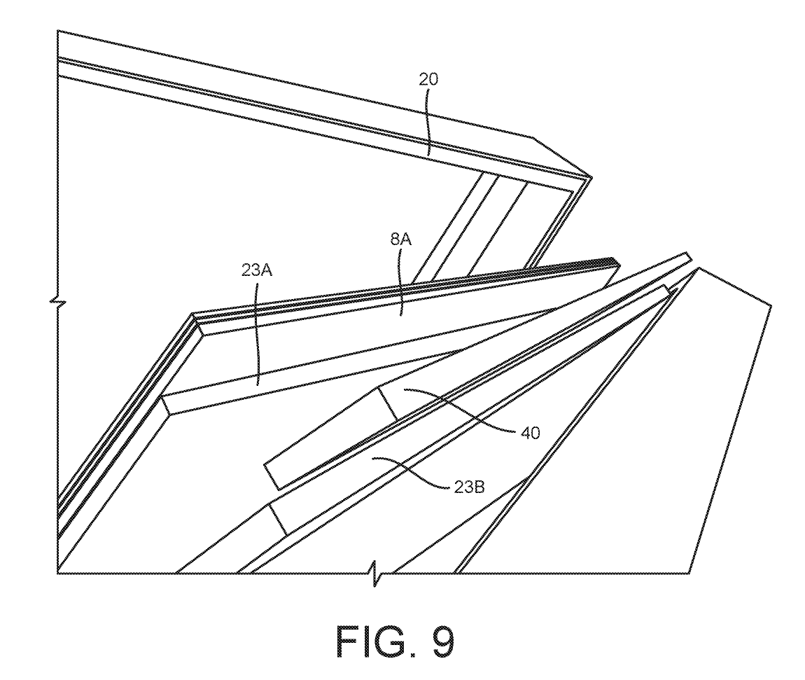

FIG. 8 shows an alignable multipiece door component 8A having 3 layers 80A, 80B, and 80C, with each layer being intimately connected such as with an adhesive

Each layer can be formed of identical fiberboard.

In embodiments, the middle layer can be made from closed cell foam.

The closed cell foam can have a density from 1 pound per cubic foot to 10 pounds per cubic foot as a layer of the multipiece door component.

In embodiments, the removable insert is a closed cell foam having a density from 1 pound per cubic foot to 10 pounds per cubic foot.

In embodiments the system can sustain an impact pressure from the alignable multipiece door components from 1 psi to 40 psi without deforming the walls and sustain an external impact pressure external to the shipping container from 1 to 100 psi without deforming the walls.

In embodiments, the low cost environmentally sustainable system consists of the walled shipping container, the removable insert, at least two alignable multipiece door components, and a component connector weighing from 110 pounds to 20 pounds enabling shipping of the system by non-customized commercial shipping rates.

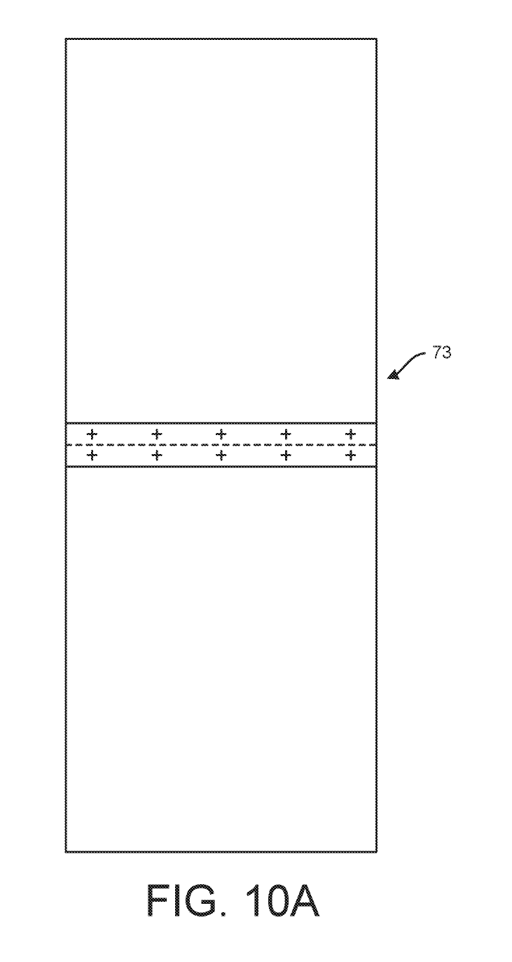

FIG. 9 shows an exploded view wherein a first alignable multipiece door component 8A with connector 40 component is nested between the removable insert 20 and a first spacer 23A, and the connector 40 is nested between a second spacer 23B and the first spacer 23A.

FIG. 10A shows an assembled door 73 according to an embodiment of the invention.

FIG. 10B shows a rolling barn door consisting of an assembled door 73, a roller 70 and a rail 72.

### Example 1

Company XYZ has a low cost environmentally sustainable system for lightweight transporting of alignable multipiece door components 8a, 8b which form an assembled door when assembled to clients.

The system contains a walled shipping container 10 that has a width of 4 ft and a height of 5 ft. The ship container has walls 12a-12d with a height of 5 ft. A top 14, which has a height of 5 ft and a width of 4 ft, extends over the walls and bottom 16 connecting the walls opposite the top. The walled shipping container independently or in combination contains the alignable multipiece door components 8a, 8b.

A removable insert 20 in the walled shipping container providing impact damping and spacing from the walls from the top and from the bottom simultaneously by covering at least 80 percent surface area of the walls, the top and the bottom. The removable insert can be rectangular.

A plurality of alignable multipiece.

door components 8a, 8b in the walled shipping container are enveloped by the removable insert.

A component connector 40 in the walled shipping container enveloped by the removable insert for engaging pairs of alignable multipiece door components forming an assembled door. The connector secures the plurality of alignable multipiece door components together.

The walls through load transfer via the removable insert support a portion of the alignable multipiece door components within the walled shipping container during transportation. The walled shipping container is designed to flex and absorb only part of and not the entirety of the horizontal forces generated by the alignable multipiece door components during alignable multipiece door component transportation so that when a portion of the alignable multipiece door components contacts the portion of the removable insert connected to at least one wall of the walled shipping container.

The alignable multipiece door component is prevented from applying a load to the at least one wall of the walled shipping container which exceeds the elastic limit of the wall of the walled shipping container.

While these embodiments have been described with emphasis on the embodiments, it should be understood that within the scope of the appended claims, the embodiments might be practiced other than as specifically described herein.

What is claimed is:

1. A low cost environmentally sustainable system for lightweight transporting of alignable multipiece door components which form an assembled door, the low cost environmentally sustainable system, comprising:
a. a walled shipping container having a top with a plurality of walls around a first face, engaging a bottom with a plurality of walls around a second face;
b. a removable insert in the walled shipping container providing impact damping and spacing from the walls, from the top and from the bottom simultaneously by covering at least percent surface area of the walls, the top, and the bottom;
c. a plurality of alignable multipiece door components in the walled shipping container enveloped by the removable insert on five sides;
d. a removeable protective spacer covering the plurality of alignable multipiece door components;
e. a component connector in the walled shipping container enveloped by the removable insert for engaging pairs of the plurality of alignable multipiece door components;
f. a plurality of fasteners for engaging the plurality of alignable multipiece door components through predrilled holes in the component connector forming an assembled door; and
wherein the walls through load transfer via the removable insert, support a portion of the plurality of alignable multipiece door components within the walled shipping container during transport, the walled shipping container designed to flex and absorb only part of and not the entirety of the horizontal forces generated by the alignable multipiece door components during alignable multipiece door component transport so that when a portion of the plurality of alignable multipiece door components contact the portion of the removable insert connected to at least one wall of the walled shipping container, each alignable multipiece door component is simultaneously prevented from applying a load to each wall of the walled shipping container which exceeds the elastic limit of each wall of the walled shipping container.

2. The system of claim 1, wherein the removable insert is a member of the group of a structural open cell foam, a structural polystyrene foam, a structural polyurethane foam, and a sprayed in place rubber-based insert.

3. The system of claim 1, comprising a finish protection bag for the low cost environmentally sustainable system for lightweight transporting of plurality of alignable multipiece door components, wherein the finish protection bag encapsulates the low cost environmentally sustainable system for lightweight transporting of plurality of alignable multipiece door components within the removable insert.

4. The system of claim 3, wherein the finish protection bag contains the component connector.

5. The system of claim 1, wherein the component connector comprises 4 to 30 predrilled holes and 4 to 30 fasteners for installation in the predrilled holes connecting a first alignable multipiece door component to a one or more subsequent door components.

6. The system of claim 1, wherein the component connector is an H shaped connector comprising a plurality of predrilled holes, and a plurality of fasteners for installation in the predrilled holes connecting a first alignable multipiece door component to one or more subsequent alignable multipiece door components.

7. The system of claim 1, comprising a roller assembly for supporting the assembled door forming an assembled door on an installed rail forming a rolling barn door.

8. The system of claim 1, wherein at least two alignable multipiece door components to form an assembled door are identical in shape and size.

9. The system of claim 1, wherein at least two alignable multipiece door components to form an assembled door are not identical in at least one of: a shape and a size.

10. The system of claim 1, wherein at least two alignable multipiece door components of the plurality of alignable multipiece door components are aligned on a common vertical axis.

11. The system of claim 1, wherein each alignable door component comprises a plurality of connected layers.

12. The system of claim 1, wherein the removable insert is a closed cell foam having a density from 1 pound per cubic foot to 10 pounds per cubic foot.

13. The system of claim 11, wherein one of the connected layers is a closed cell foam layer.

14. The system of claim 1, wherein the system sustains an internal impact pressure from the alignable multipiece door components from 1 psi to 40 psi without deforming the walls and sustain an external impact pressure external to the shipping container from 1 psi to 100 psi without deforming the walls.

15. The system of claim 1, wherein the walled shipping container has a girth plus length of no more than 165 inches with a width 15 from 10 inches to 50 inches, and a height 11 from 6 inches to 100 inches and a thickness from 4 inches to 20 inches.

16. The system of claim 1, wherein the walled shipping container walls are single wall, double walled, triple walled, or reinforced multi-walls.

17. The system of claim 1, wherein the low cost environmentally sustainable system consisting of the walled shipping container, the removable insert, at least two alignable multipiece door components, and a component connector weighs from 110 pounds to 20 pounds enabling shipping of the system by non-customized commercial shipping rates.

18. The system of claim 1, comprising assembly instructions comprising: a URL address connecting to online instructions or digital media contained in the walled shipping container playable on a client device of an assembler.

19. The system of claim 1, wherein the top fits over the bottom.

20. The system of claim 1, wherein each alignable multipiece door component is from 5% to 50% less than at least two dimensions of the removable insert.
